(19) United States
(12) Patent Application Publication
(10) Pub. No.: US 2020/0118179 A1
(43) Pub. Date: Apr. 16, 2020

(54) SYSTEMS AND METHODS FOR MANAGING FUNDRAISING ACTIVITIES

(71) Applicant: ViewSpark LLC, Carlsbad, CA (US)

(72) Inventors: William F. Kliewer, Newhall, CA (US); Jeff Kliewer, Carlsbad, CA (US)

(21) Appl. No.: 16/626,237

(22) PCT Filed: Jun. 22, 2018
(86) PCT No.: PCT/US18/39165

§ 371 Date: Dec. 23, 2019

Related U.S. Application Data
(60) Provisional application No. 62/523,746, filed on Jun. 22, 2017.

(51) Int. Cl. G06Q 30/02; G06Q 10/10

(52) U.S. Cl. CPC G06Q 30/0279; G06Q 10/107; G06Q 30/0255

(57) ABSTRACT

Systems and methods for managing fundraising and donors through an interactive platform are provided to allow fundraiser organizers to manage donations, donor profiles and other fundraising analytics, while also creating donor-specific content delivered directly to specific segments of donors using a prioritized hierarchical communication system in order to increase engagement and retention of donors. Donors are provided with a customized content platform via an interactive feed, with additional options for creating customized donations to various fundraisers and selecting their own communication hierarchy for receiving content via multiple types of electronic communications, including text, e-mail, application and device notifications, etc. Fundraiser organizers can create dynamically-updated segments of donors based on donor profiles and donor activity such as recency, frequency and amount of donations made.

### BACKGROUND

### Field of the Invention

Systems and methods provided herein relate to managing fundraising activities with an interactive donation and fundraising platform, and more specifically to an application for requesting and receiving funds, creating analytics-driven donor profiles, and generating and delivering digital content related to the fundraising activity to segmented sets of donors using prioritized communication hierarchies to increase donor engagement and retention.

### Related Art

Technology advancement for nonprofit organizations continues to lag 5-10 years behind the for-profit sector. While retail shoppers can track and follow an online purchase at all points from click-to-doorstep, most donors to nonprofits have no idea what has resulted from their charitable contributions. They can only hope to receive a “thank you for your generous gift” email or hardcopy letter months after making their donation.

This lack of donor engagement has a crippling effect on a nonprofit's ability to create trust, retain donors, and leads to skyrocketing overhead expenses. With email quickly becoming the next form of “junk mail,” nonprofits have turned to crowdfunding, but the resulting income lift has been lackluster. They long for technology to engage and solicit existing donors and know that this capability would infuse donors with the joy of giving, encouraging them to give again.

Therefore, it is desirable to develop systems and methods to improve interactions with donors to increase donor engagement and retention.

### SUMMARY

Embodiments described herein provide for systems and methods for managing fundraising and donors through an interactive platform which allows fundraiser organizers to manage donations, donor profiles and other fundraising analytics while also creating donor-specific content delivered directly to specific segments of donors with a prioritized hierarchical communication system in order to increase engagement and retention of donors. Donors are provided with a customized content platform with the customized content presented in an interactive feed, with additional options for creating customized donations to various fundraisers and selecting their own communication hierarchy for receiving content via multiple types of electronic communications, including text, e-mail, application and device notifications, etc. Fundraiser organizers can create segments of donors based on donor profiles and donor activity such as recency, frequency and amount of donations made, and the segments can be dynamically-updated based on real-time donation information. An organizer can then provide appropriate content to each segment based on the donor profile, donor activity and communication hierarchy in order to engage donors with one or more fundraisers on an individual level. The application creates separate, customized platforms for fundraiser organizers, donors and even administrators and collaborators to facilitate real-time interactions and feedback for fundraisers, facilitating donor engagement and increasing fundraiser intelligence.

In one embodiment, a system for managing fundraising comprises a content engine which creates content related to at least one fundraiser for publishing to a plurality of donors; a segmentation engine which creates, manages and selects segments of the plurality of donors to receive customized content selected from the created content; a hierarchy engine which publishes the customized content to the selected segments of donors using a prioritized hierarchy of communication mediums; and a donation platform which receives donations from the plurality of donors for the at least one fundraiser.

In another embodiment, a method for managing fundraising comprises: creating content related to at least one fundraiser for publishing to a plurality of donors; creating, managing and selecting segments of the plurality of donors to receive customized content selected from the created content; publishing the customized content to the selected segments of donors using a prioritized hierarchy of communication mediums; and receiving donations from the plurality of donors for the at least one fundraiser.

In a further embodiment, a system for interacting with a fundraiser comprises: an interactive donor dashboard displaying information on at least one fundraiser to a donor; the interactive donor dashboard comprising: donor profile information including the donor's fundraiser preferences and donation activity; interactive content relating to at least one fundraiser selected for the donor based on the donor profile information; and graphical interfaces for donating to the at least one fundraiser.

In a yet further embodiment, a system for a system for interacting with a donor comprises an interactive fundraiser dashboard displaying information on a plurality of donors and fundraisers to a fundraising organizer; the interactive fundraiser dashboard comprising: content creation tools for creating, requesting and receiving content related to the plurality of fundraisers; segmentation tools for creating, managing and selecting one or more segments of donors to receive customized content selected from the content; hierarchy selection tools for selecting a prioritized hierarchy of communication mediums for publishing the customized content to the selected segments of donors; and fundraiser analytics tools for analyzing information relating to the plurality of donors and fundraisers and interactions therewith.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a diagram illustrating an example system for managing fundraisers, according to an embodiment of the invention;

FIG. 2 is a diagram illustrating an example communication platform for managing fundraisers, according to an embodiment of the invention;

FIG. 3 is an image of a fundraiser dashboard on a mobile application, according to an embodiment of the invention;

FIG. 4 is an image of a fundraiser dashboard on a desktop application, according to an embodiment of the invention;

FIG. 5 is an image of a content creation page, according to an embodiment of the invention;

FIG. 6 is an image of a collaborator content request page, according to an embodiment of the invention;

FIG. 7 is an image of a segment creation page, according to an embodiment of the invention;

FIG. 8 is an image of a list of segments created for a fundraising campaign or fundraiser, according to an embodiment of the invention;

FIG. 9 is an image of a hierarchy selection page, according to an embodiment of the invention;

FIG. 10 is an image of a fundraiser organizer hierarchy selection page, according to an embodiment of the invention;

FIG. 11 is an image of a donation summary page, according to an embodiment of the invention;

FIG. 12 is an image of a donor summary page, according to an embodiment of the invention;

FIG. 13 is an image of a donation request page, according to an embodiment of the invention;

FIGS. 14A and 14B are images of an additional donation request page, according to an embodiment of the invention;

FIG. 15 is an image of a donor user profile page, according to an embodiment of the invention;

FIG. 16 is an image of a donor hierarchy selection page, according to an embodiment of the invention;

FIG. 17 is an image of a donor content news feed page displayed on a mobile application, according to an embodiment of the invention;

FIG. 18 is an image of interactive donor content, according to an embodiment of the invention;

FIG. 19 is an image of a donor content news feed page displayed on a desktop application, according to an embodiment of the invention;

FIG. 20 is an image of interactive donor content displayed on a desktop application, according to an embodiment of the invention;

FIG. 21 is an image of a fundraiser donation summary page, according to an embodiment of the invention;

FIG. 22 is an image of an additional fundraiser donation summary page, according to an embodiment of the invention;

FIG. 23 is a flow diagram illustrating an example process for managing a fundraiser, according to an embodiment of the invention;

FIG. 24 is a flow diagram illustrating a further example process for managing a fundraiser, according to an embodiment of the invention; and

FIG. 25 is a block diagram illustrating an example wired or wireless processor enabled device that may be used in connection with various embodiments described herein.

### DETAILED DESCRIPTION

Certain embodiments disclosed herein provide for systems and methods for managing fundraising and donors through a mobile application which allows fundraisers to manage donations, donor profiles and other analytics while also creating donor-specific content which can be delivered directly to the donor across prioritized hierarchical channels to increase engagement and retention of donors for one or more fundraising campaigns. Donors are provided with an interactive donor platform where they can create customized and recurring donations, view and interact with content related to selected fundraisers and create donor profiles to customize fundraiser content and communication preferences. Fundraiser can segment donors into specific groups based on donor profiles, donor activity and other giving history data in order to customize content for the specific groups, manage fundraisers using real-time analytics and create fundraiser-specific hierarchies of communication mediums for broadcasting the content to the donors in order to maximize the chances of donor engagement. The application creates a single portal for fundraisers, donors and team members to interact electronically and in real-time to share and experience the benefits of donations and fundraising campaigns.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

The systems and methods provided herein enable organizations, companies and non-profits to share relevant, targeted real-time content from the field with donors, all through a simplified mobile or desktop application which allows the management of fundraising campaigns, donors and donor content. The donations may be requested electronically through the application or via other electronic forms of communication such as device or in-app notifications, text or multimedia messaging, push notifications, e-mail messaging, social media posting and messaging, or an in-app news feed. Fundraisers can target donors based on specific donor profile data and activity, for example historical giving history which included amount, frequency and recency of giving and types of fundraising campaigns the donor is involved with. Fundraiser organizers can also create donor-specific content to engage donors and help them relate to and understand the benefit of their donation, created by the fundraiser or collaborators in the field who are carrying out the mission the particular donor made a gift to support. Fundraiser organizers can request that collaborators create content in order to better engage the donors with real-time content and increase the frequency of donations and retention of donors for one or more fundraising campaigns. On the donor side, donors receive the content via a news feed or other formatted notification update and can then comment, react and share with others to more fully engage with the fundraiser.

The embodied systems and methods therefore provide a cost-effective method to acquire, engage, retain and upgrade donors to one or more fundraising campaigns.

### Fundraiser Communication Platform

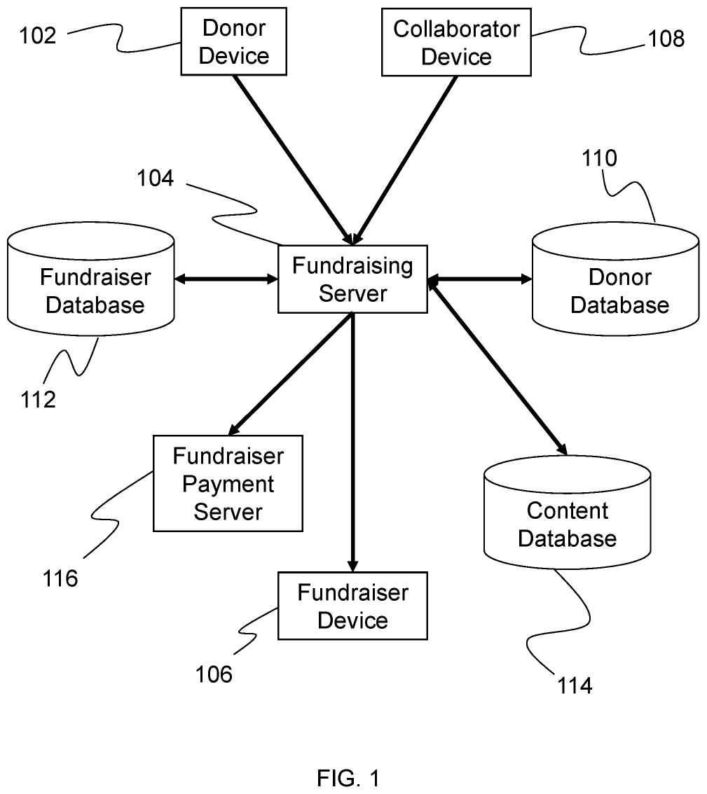

FIG. 1 is a diagram illustrating an example system for managing fundraisers, according to an embodiment of the invention. In this exemplary system, a plurality of devices such as a donor device 102, fundraiser device 106 and collaborator device 108 are in communication with a fundraising server 104 which receives and transmits data relating to fundraising campaigns, donations and donors. The data relating to fundraising campaigns, donors and donor-specific content may be stored in individual databases or sections of a single database such as a fundraiser database 112, donor database 110 and content database 114. In one embodiment, donations received from the donor device 102 are directed to a payment gateway hosted on a fundraiser payment server 116 so that the donations are made directly to each organization hosting a fundraiser. The devices can therefore all interact with the fundraising server 104 in order to manage fundraising campaigns, as will be provided in further detail below.

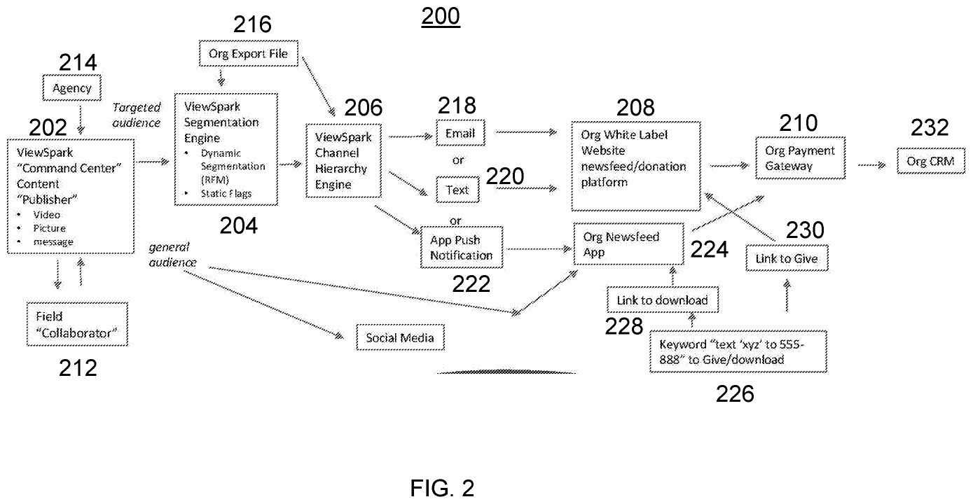

FIG. 2 is a diagram illustrating an example communication platform 200 for managing fundraiser, according to an embodiment of the invention. Illustrated in this diagram are the various engines which operate to achieve the overall systems and methods for managing fundraisers, including the content engine 202 (“Command Center”), segmentation engine 204, hierarchy engine 206, donation platform 208, and organization payment gateway 210.

With regard to the content engine 202, as illustrated herein, the content, such as a video, picture, message, etc. may be created by a fundraiser organizer with the engine, or by a collaborator 212 or contracted agency 214 who has been tasked with creating content. The collaborator 212 may be a member of the fundraiser organizer's team who is working in the field to execute the goals of the fundraiser, such as a charitable organization which is building a well in a drought-ridden country. The collaborator 212 may receive a request from the fundraiser organizer to send images of the construction of the well which can then be distributed to the various donors. The images are then received at the content engine 202.

Once the content is created, the segmentation engine 204 is utilized to create one or more segments of donors which will receive some or all of the content in a customized way. The segmentation engine may receive donor information from the organization's separate files 216 which can be exported from the fundraiser organization into the communication platform 200. For example, large donors may receive more updates on a regular basis, or receive personalized messages and content from collaborators or even people who are the beneficiaries of the fundraiser. The segmentation engine 204 can dynamically update all of the segments in real time or any time a fundraiser updates the system based on the activity of the various donors so that the fundraiser organizer is not required to manually update the various segments each time a new donation or requisite activity occurs that requires changing the segments. In addition to the dynamically updated segments, some segments may be static, such as board members of the organization who will receive all updates related to all fundraisers on the system.

Next the hierarchy engine 206 is utilized to determine the communication medium on which the segmented donors will receive the content. The content may be distributed either via email 218, text 220, push notification or in-app updates 222, etc. Once the content is published to the donors, the donors can then view the content via their donation platform 208, which may be viewed via an application on a mobile or computing device, on a website on a mobile or computing device, or on any other electronic device with a processor and display. The content may be arranged in a newsfeed format 224, as will be described below. The donation platform 208 also will provide options for the donor to make further donations, and those donations are routed to the organization's payment gateway 210 so the payments can be directly sent to each organization.

As noted in FIG. 2, another option for receiving information on the application may be made by keyword text messages 226 where a donor sends a text message with a keyword to a particular number and then subsequently receives a response message with a link to download 228 the fundraiser application on an electronic device. In one embodiment, the link may be a direct giving link 230 to donate to a fundraiser instead of to download the application itself.

Finally, as noted in FIG. 2, the donation information may be passed on to an organization's customer resource management (CRM) software 232 for integration into the organizations' own information systems or for reintegration into the fundraiser dashboard and analytics system, as will be further described below.

### Fundraiser Platform

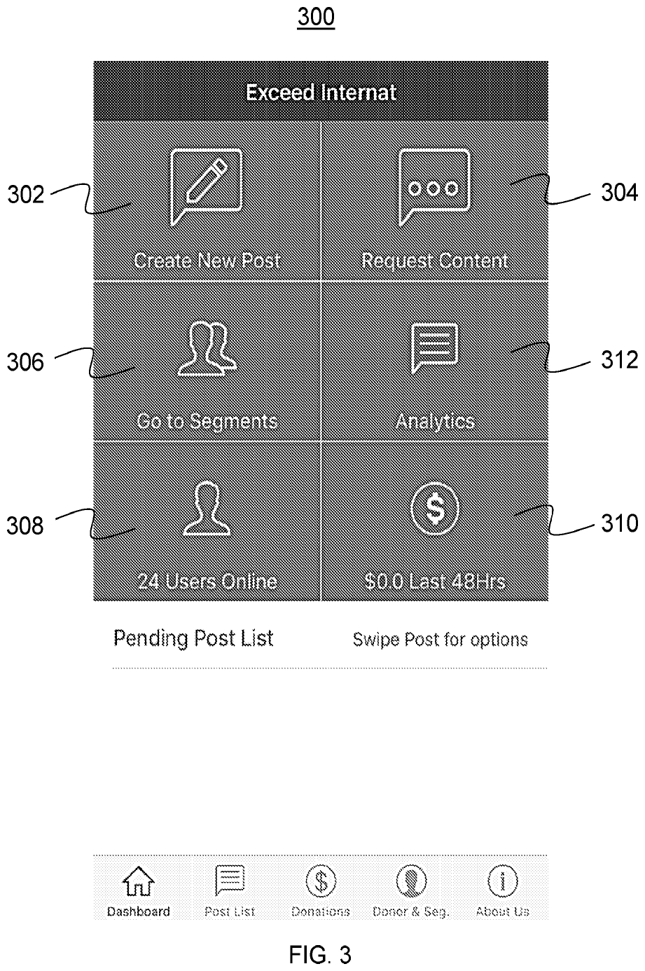

FIG. 3 is an image of a fundraiser dashboard 300 on a mobile application, according to an embodiment of the invention. The dashboard 300 allows a fundraiser to manage a fundraising campaign, donors, create 302 or request 304 donor-specific content, manage segments 306, users currently active with the application 308, donations 310, team members and more all from a single user interface on a mobile computing device or desktop computing device. In addition to basic information such as a quick summary of donations recently received, the fundraiser can also view a plurality of analytics 312 related to the amount of donations received over recent periods of time, the amount of users engaged with the application, and when the users are engaged with the application and with which fundraisers, although these are only a few examples of the analytics available to the fundraiser. Fundraisers may also have access to educational content to help them create fundraisers, donor-specific content and various donor segments to maximize the effectiveness and reach of their fundraisers. The specifics of these features on the dashboard will be described in further detail below.

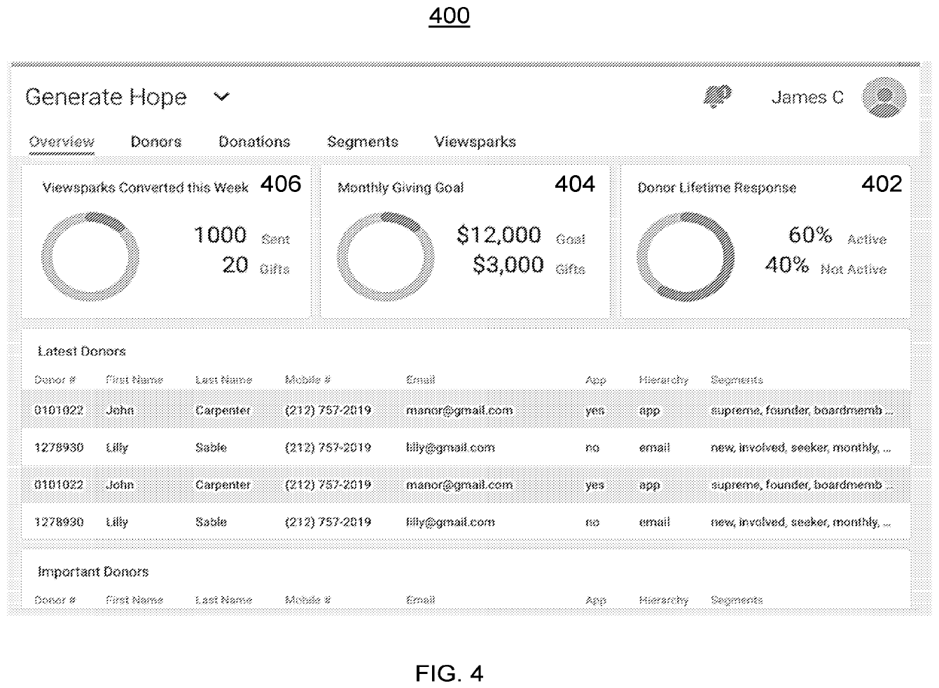

FIG. 4 is an image of a fundraiser dashboard 400 on a desktop application, according to an embodiment of the invention, with additional graphical elements showing the progress of the fundraiser, such as lifetime responses 402 or monthly goals 404, and metrics on a “conversion” rate of donations 406 received in response to content that it sent. This information is additionally part of the fundraiser analytics that an organizer can view to better manage a fundraiser.

### Content Creation Engine

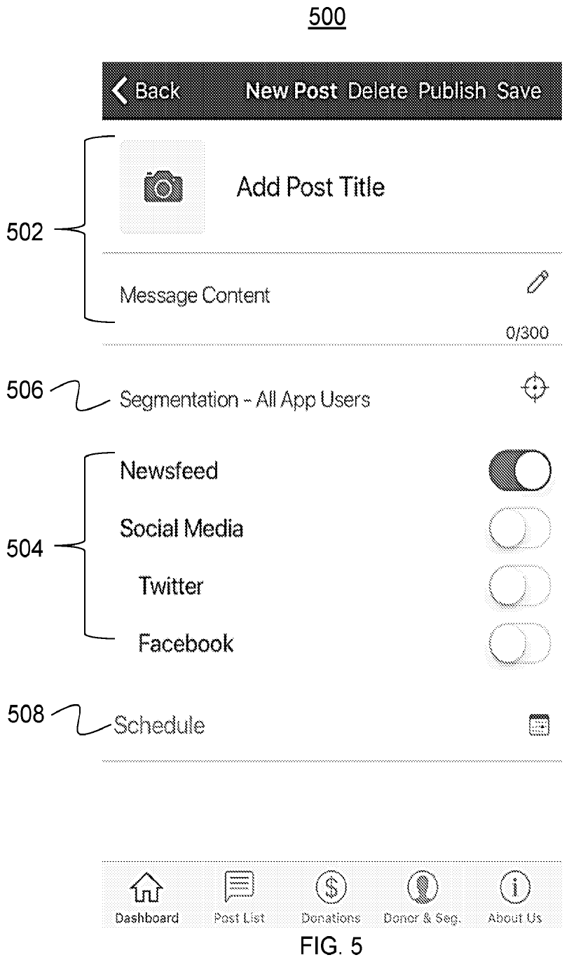

FIG. 5 is an image of a donor content creation page 500, according to an embodiment of the invention. In one example, the donor content may be content related to the work being done by an organization as a result of the funds provided by the donor. When the fundraiser selects the “Create New Post” icon on the dashboard (302 in FIG. 3), the donor content creation page 500 is provided, which allows a fundraiser to create content 502 related to a fundraising campaign and select one or more methods 504 to deliver that content to a donor. The donor content may include text, images, video, audio, hyperlinks or any other type of media that will allow a donor to view and understand the benefits of their donation to a particular fundraising campaign. The donor content may be tailored to a specific segment of donors based on the fundraiser they donated to, the amount they donated, their desired level of participation and feedback in the fundraiser, and other relevant donor-specific factors. Once the donor content has been created, the fundraiser can select one or more methods of content delivery, such as publication to a news feed within the application, publication to one or more social media feeds, or even direct delivery to the donor via text, e-mail or in-app notification. The fundraiser can also select one or more segments 506 of donors for which the content will be delivered, as will be described in further detail below. Finally, the fundraiser can schedule 508 the donor content for delivery at a particular time, which may be specific to individual donors using information obtained from the donor profiles as to when the donors typically interact with the application or make donations to various fundraising campaigns.

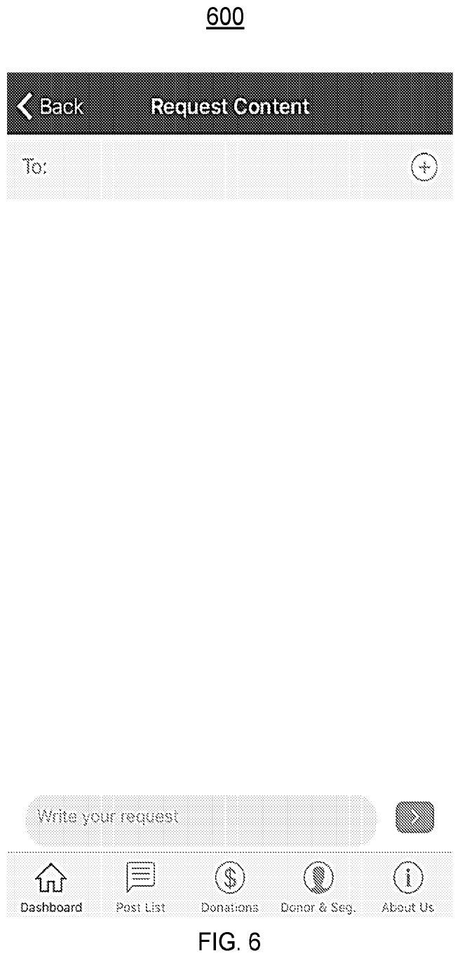

FIG. 6 is an image of a collaborator content request page 600, according to an embodiment of the invention. If a fundraiser wants to create content directly related to work that a collaborator is doing in the field as a result of received donations, the fundraiser can interact with the collaborators or team members directly through the application to request that the team members create content. This content could be pictures, videos, audio, or written information that provides a detailed report of the progress of a project for which the fundraiser was created, or outline a further need in order to solicit further donations from the donors. Additionally, the collaborator may provide a real-time messaging or live video streaming broadcast directly to the donors. The team member can then send the content to the fundraiser for publication to one or more segments of donors, or in some cases the team member can send the content directly to one or more segments of donors.

### Segmentation Engine

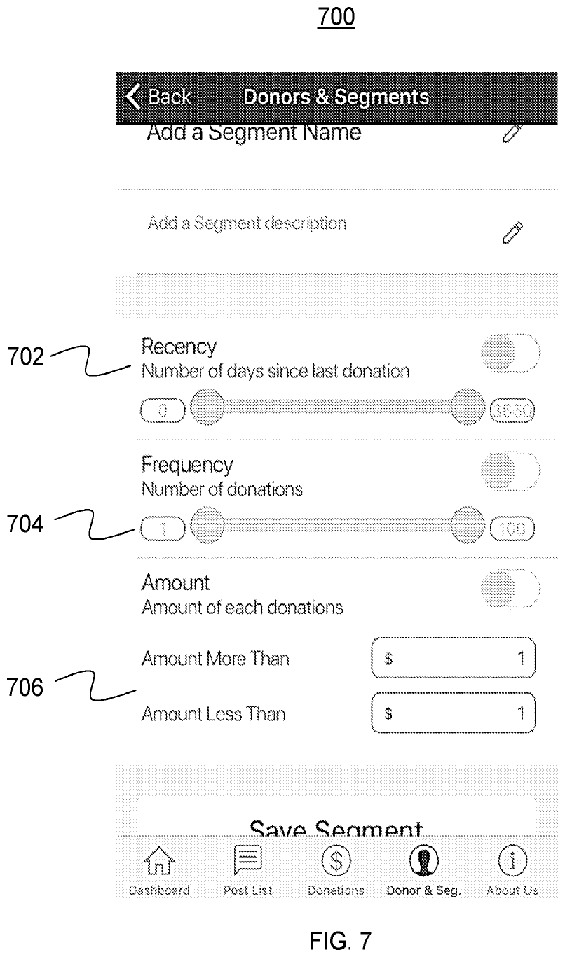

FIG. 7 is an image of a segment creation page 700, according to an embodiment of the invention. This page allows the fundraiser to create one or more segments of donors for sending donor-specific content or donor-specific donation requests. The segments of donors may be created using a plurality of donor profile information, such as how recently 702 the donor sent a donation, how frequently 704 a donor sends donations, the amount 706 of the donation. Other relevant demographic and user-specific data may also be utilized, such as the fundraisers, events, organizations and employment in which the donor participates.

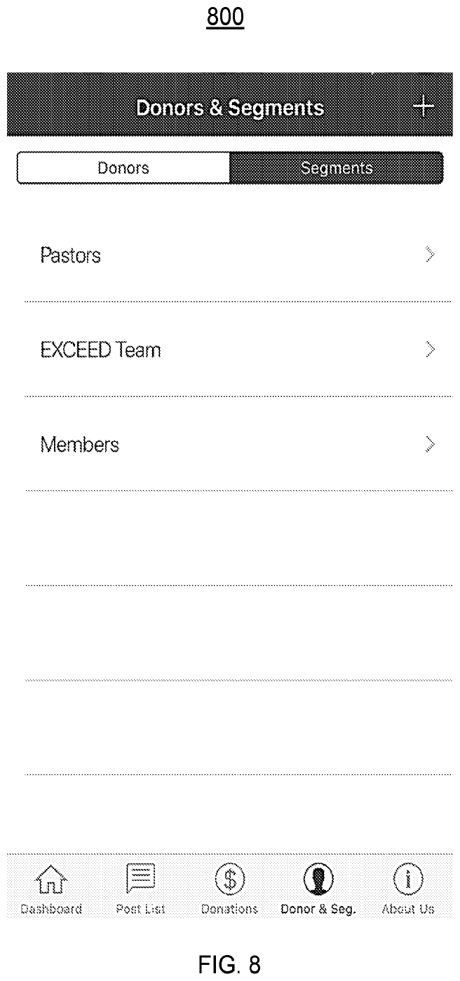

FIG. 8 is an image of a list of segments 800 created for a fundraising campaign or fundraiser, according to an embodiment of the invention. The list includes three different segments created by a particular fundraiser, which includes pastors that may receive content related to a particular fundraising need, team members who aid with the fundraising activities, and members who make up the majority of the regular donors for a particular fundraising campaign. This list illustrates the flexibility with which the segments of donors can be created, and similarly the flexibility with which donor-specific content may be created to target unique groups of donors and affiliates who may be utilized to recruit additional donors.

### Hierarchy Engine

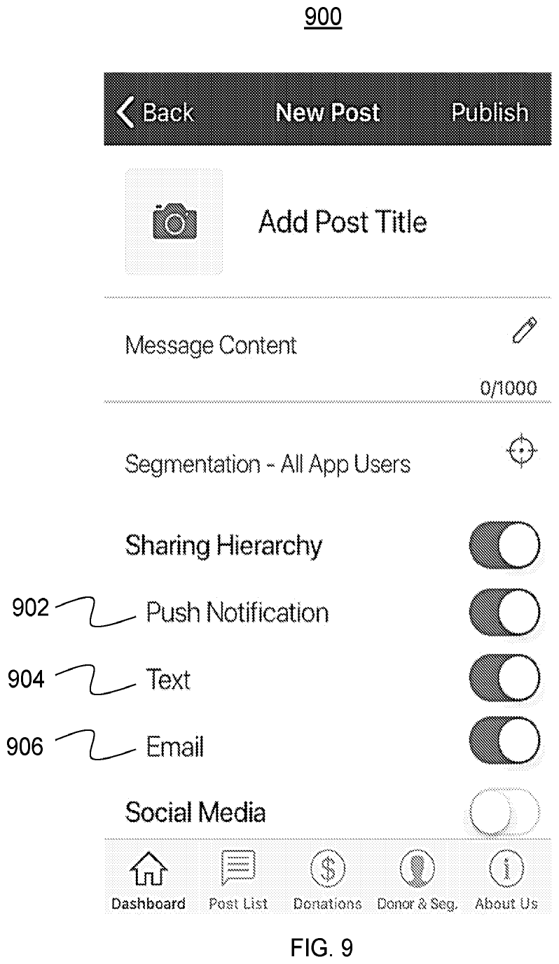

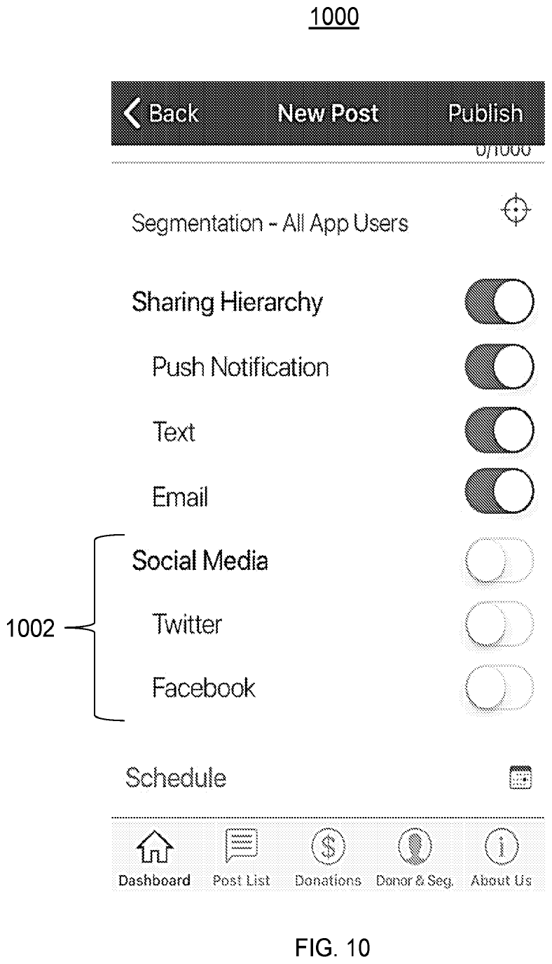

FIG. 9 is an image of a hierarchy selection page 900 which illustrates some of the options for selecting a hierarchy of communication mediums in which content may be distributed to a segment of donors or to an individual donor. As shown in the example, the communication mediums may include push notifications 902, text messages 904 and e-mail 906, each of which can be individually toggled on or off for each item of content that is created and published. One of the benefits of the hierarchy engine is that the content for a particular segment can be sent out via all of the different communication mediums in a single deployment instead of as individual requests. FIG. 10 is an image of a further section of the hierarchy selection page 1000 which provides options for distributing and publishing content via social media 1002, with various social media accounts individually listed and able to be toggled on or off. It should be noted that the publishing of content via social media is to a general audience of donors who may not belong in a specific segment if they are not registered users and simply follow the organizer on that particular social media platform.

### Fundraiser Platform

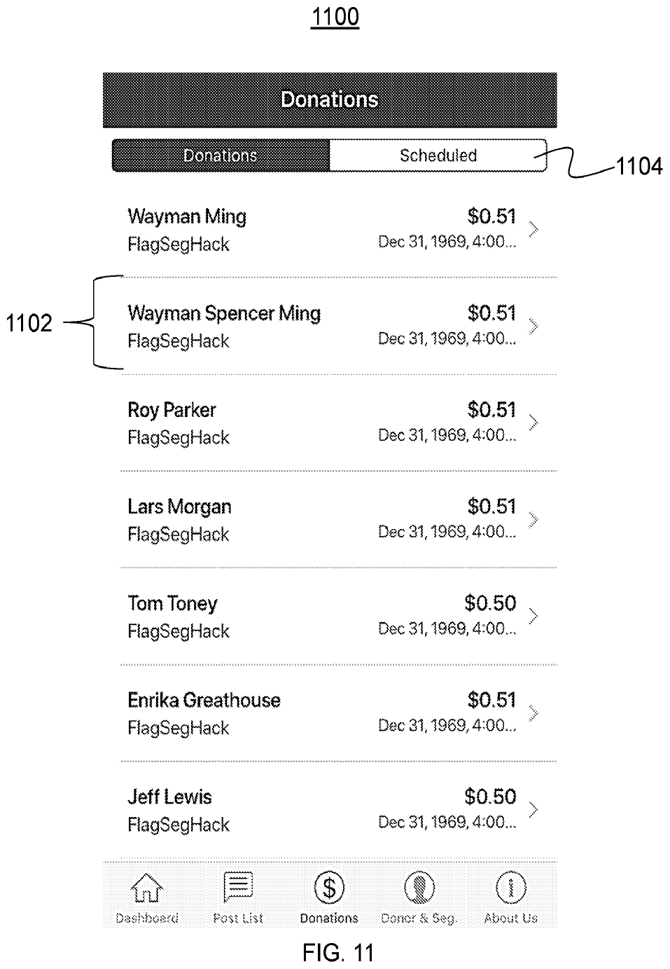

FIG. 11 is an image of a donation summary page 1100, according to an embodiment of the invention. This list illustrates the detailed information that may be obtained, stored and analyzed for a specific donor and a specific donation 1102, including the donor name, donor affiliation, fundraiser, amount, date and time of the donation. This data can be utilized as indicated above to create different segments of donors to target with donor-specific content. If the “Scheduled” tab 1104 is selected, a view of donors who have set up future or recurring donations is shown, along with when their scheduled donations will take place and the amount of the scheduled donation. This allows the fundraiser to create specific donor content in advance for delivery to the donor as soon as their scheduled donation is made.

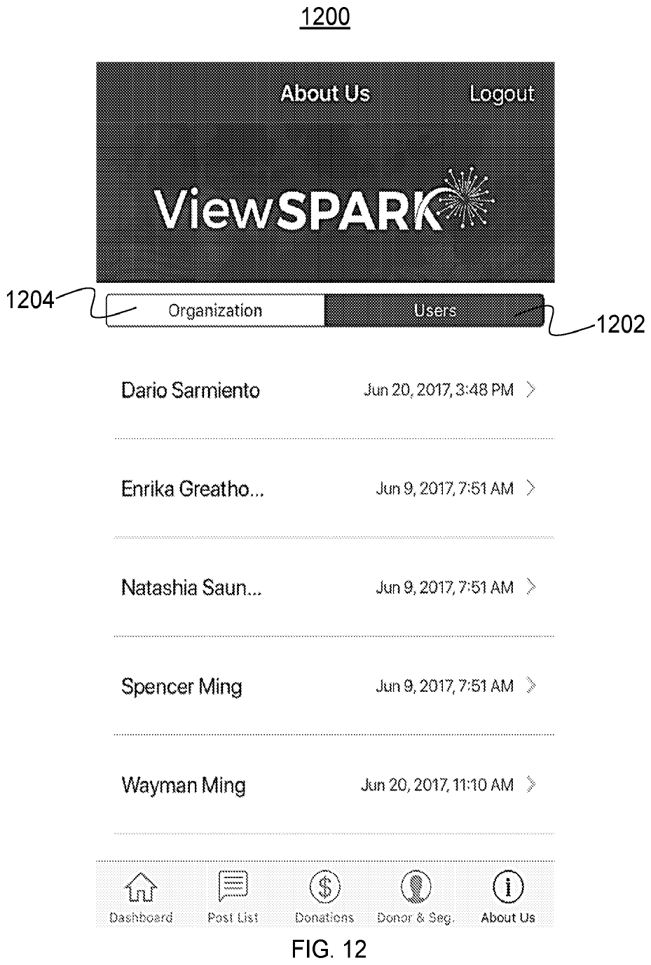

FIG. 12 is an image of a donor summary page 1200, according to an embodiment of the invention. The donor summary page provides a summary of individual donors 1202 and organizations 1204 related to the fundraising activity and allows the fundraiser to view specific information on each donor or organization for creating donor-specific content or for sending direct messages.

### Donor Platform

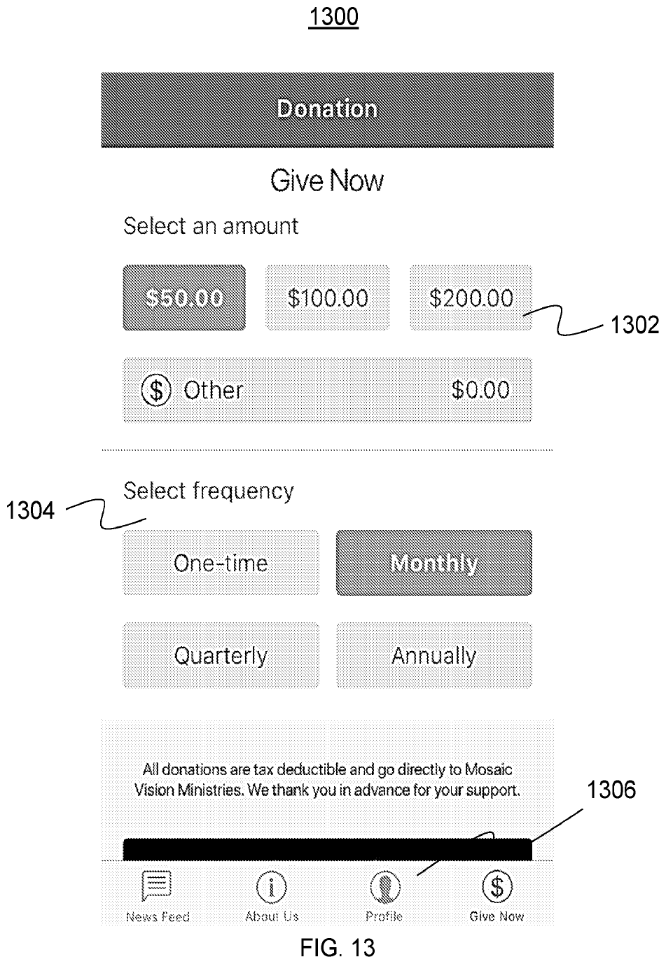

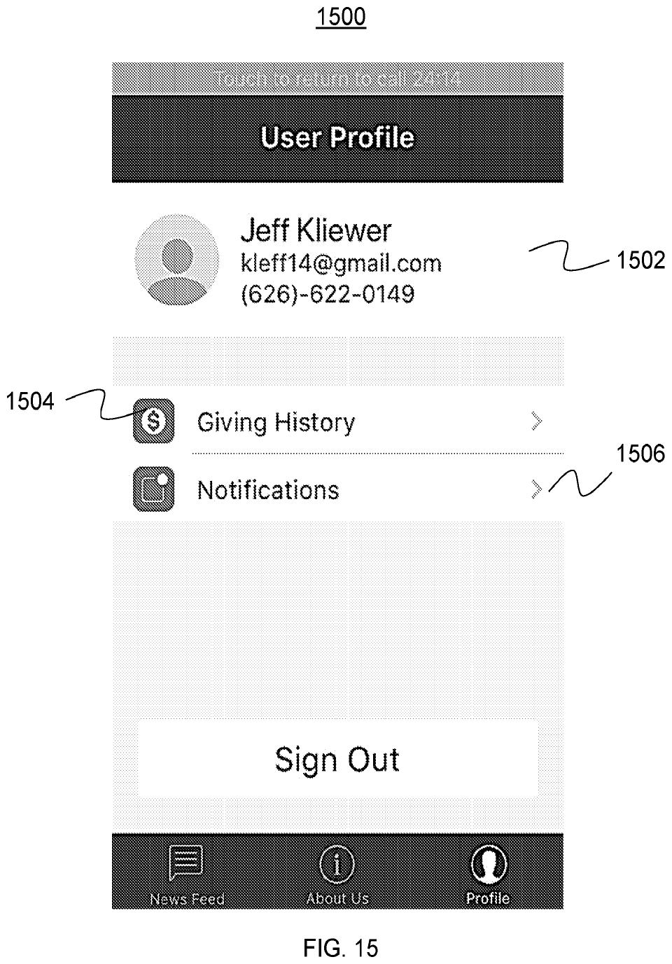

FIG. 13 is an image of a donation request page 1300, according to an embodiment of the invention. The donation request page 1300 is the page that a donor would see when viewing the application on their mobile application and would allow the donor to select a specific amount of money 1302 to donate, as well as the frequency 1304 with which to donate if they wish to make a recurring donation. The donor may also access a Profile icon 1306 at the bottom of the page to view their own donor profile information, including a history of their donations and other donor-specific content utilized by the application (see FIG. 15, below).

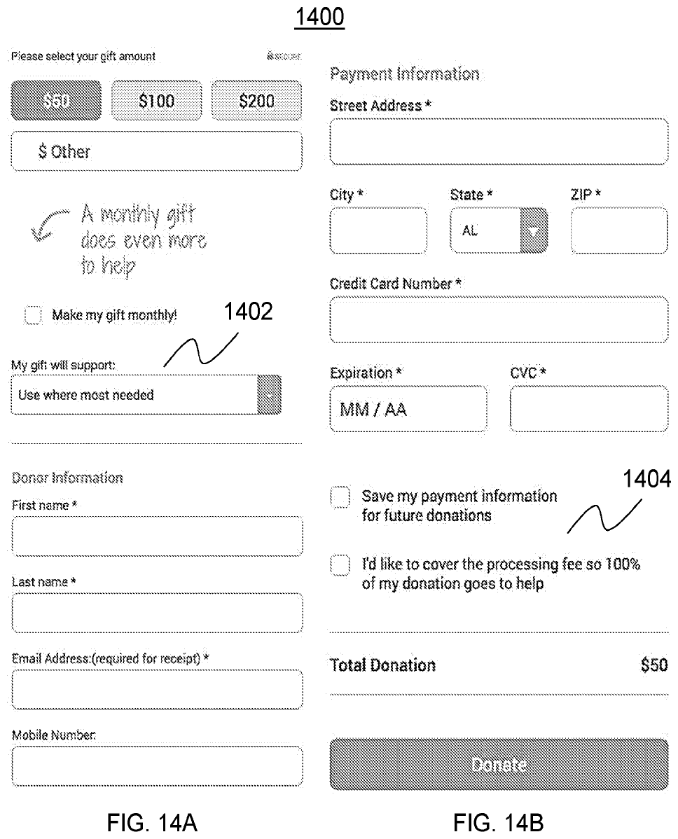

FIGS. 14A and 14B are images of a further donation request page 1400, with additional options for how a donation will be used 1402 and adding a separate donation to cover credit card processing fees 1404.

FIG. 15 is an image of a donor profile page 1500 where the donor can create a profile with their contact information 1502, payment information and other preferences for participating in fundraisers and making donations. The donor profile page may also include information on the donor's history 1504 of giving and links to notifications 1506 or messages from various fundraisers to which the donor has contributed to.

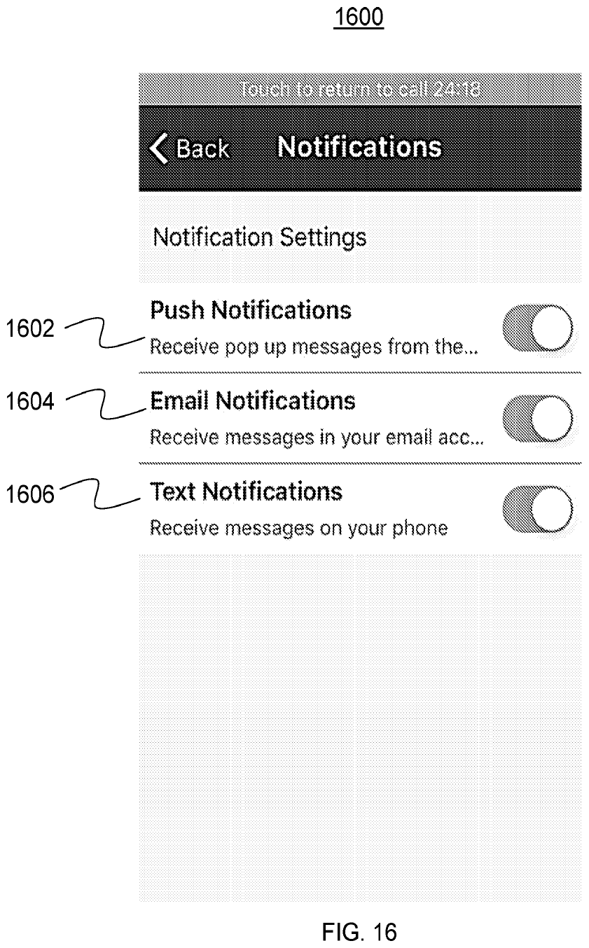

As shown in FIG. 16, the donor may also be provided with their own hierarchy selection page 1600 where they can select one or more types of communication mediums to which they prefer to receive updates from the organizer or from specific fundraisers to which they have contributed to, including push 1602, email 1604 and text 1606, just to list a few examples.

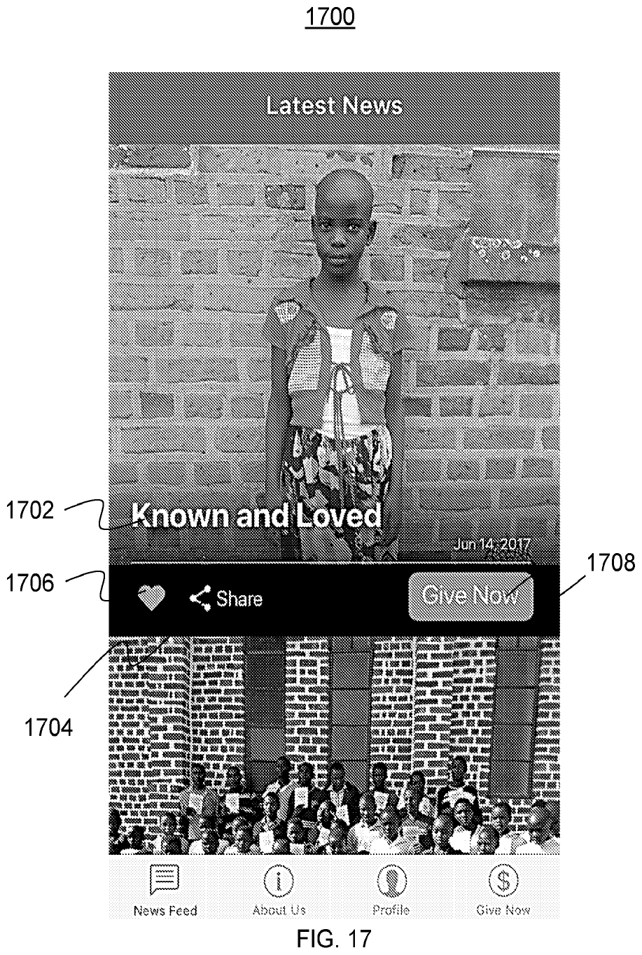

FIG. 17 is an image of a donor content news feed page 1700, according to an embodiment of the invention. In this embodiment, the news feed is populated with all of the donor-specific content relevant to a particular donor and the fundraisers for which they have donated to or been asked to donate to. The donor may be provided with a single image or title 1702 related to the content and have the ability to scroll through all of the items in the news feed and select individual items for displaying more specific content, sharing a news story 1704, reacting to the story 1706 or donating 1708. Although the content is illustrated here in the news feed, it is important to note that the donor-specific content may be delivered to the user in a variety of formats and applications; for example through publication to the donor's social media feeds, via text message or SMS multimedia messages, e-mail, or in-app notifications.

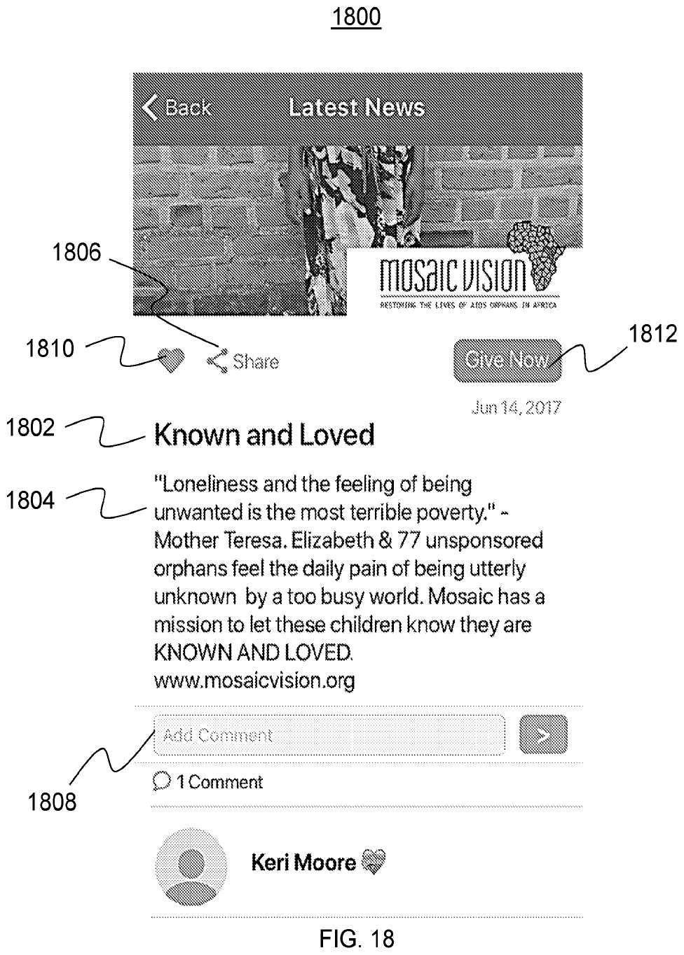

FIG. 18 is a further image of a donor content page 1800, according to an embodiment of the invention. If the donor selected the first image or title 1802 on the news feed, the detailed donor content 1804 is displayed along with the image in order to provide the donor with a specific update about, in this example, a child who has benefited from the donor's aid. The donor content may also provide options to share 1806 the content, comment 1808 on the content, react 1810 to the content and provide an additional donation 1812 to the particular fundraiser for which the content is related.

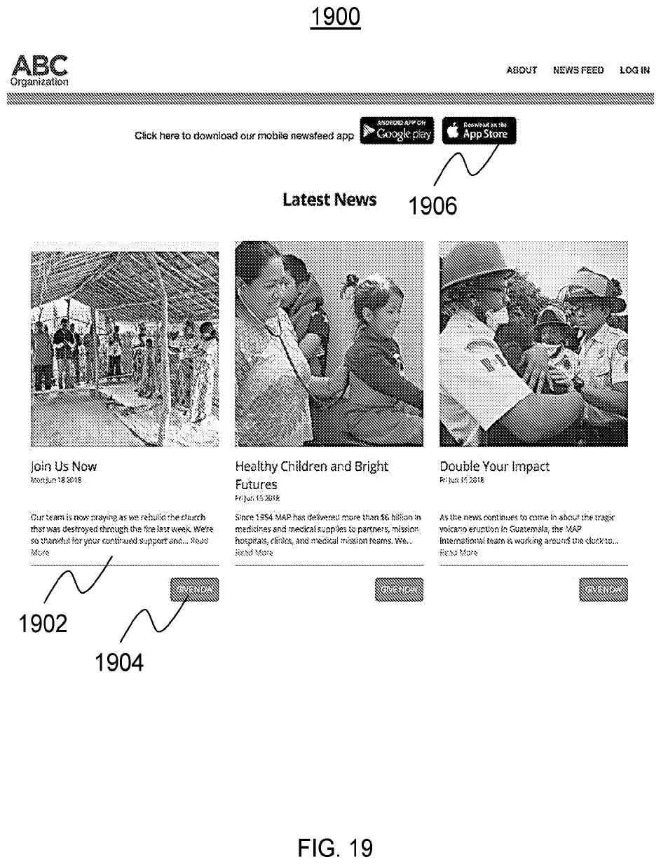

FIG. 19 is an image of a donor content news feed page 1900 displayed on a desktop computer using a web browser, according to an embodiment of the invention. In this embodiment, the news feed is generic since no user is currently signed in, so the news feed is populated basic summaries 1902 about some or all of the fundraisers without any specificity targeting a specific donor. Links are provided to donate to the fundraisers 1904 or download a mobile or desktop application 1906 for more targeted fundraising news. The donor may be provided with a single image or title related to the content and have the ability to scroll through all of the items in the news feed and select individual items for displaying more specific content, as will be shown immediately below.

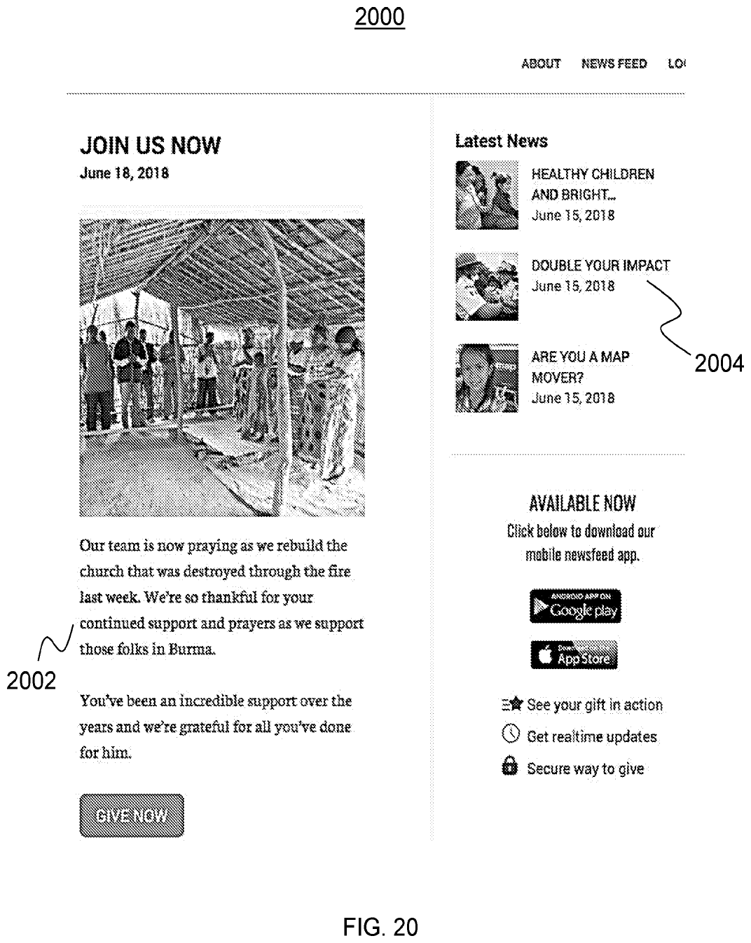

FIG. 20 is an image of a donor content page 2000 displayed on a desktop computer using a web browser, according to an embodiment of the invention. If the donor selected the first image on the news feed, the detailed donor content 2002 is displayed along with the image in order to provide the donor with a specific update about, along with additional news information 2004 provided on the right column. Although not shown here, if the donor signs into their profile, the donor content may also provide options to share the content, comment on the content, react to the content and provide an additional donation to the particular fundraiser for which the content is related.

### Fundraiser Analytics

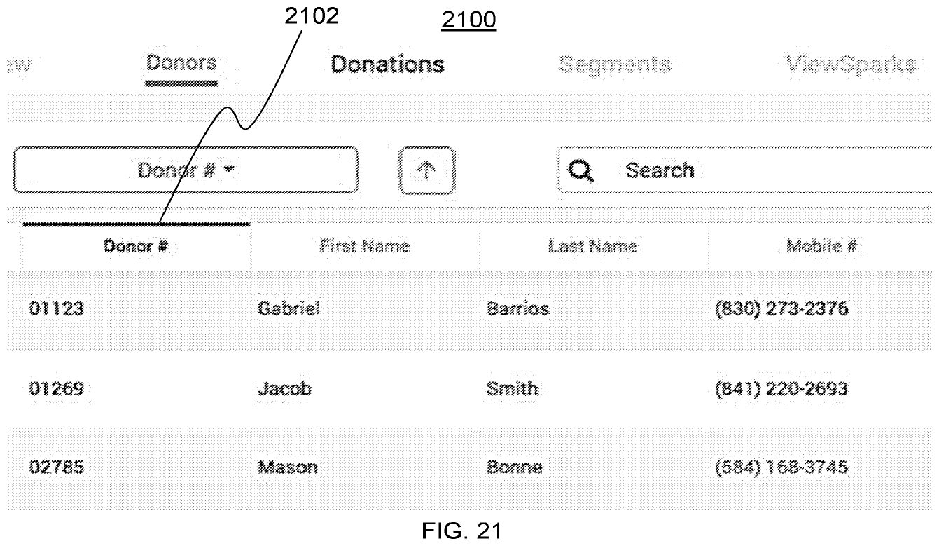

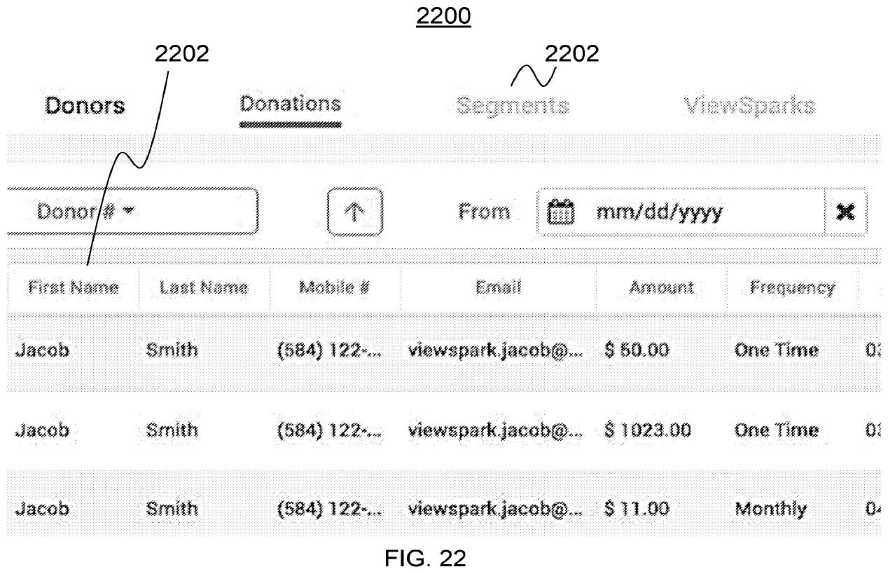

FIG. 21 is an image of a fundraising detail page 2100 which displays a list of donors 2102 (via a donor identification number) and information about the donors. This information is useful for an administrator or other member of the organization which runs the fundraisers to view details about each donor and determine whether to place certain donors in certain segments or create donor-specific content and communication to a donor. FIG. 22 is a further image of a fundraising detail page 2200 which displays a list of donations 2202 and information on each donation and related donor for a fundraiser organizer to view. The fundraiser analytics also may include information on segments, as noted by the tabs 2204 on the page.

### Exemplary Methods

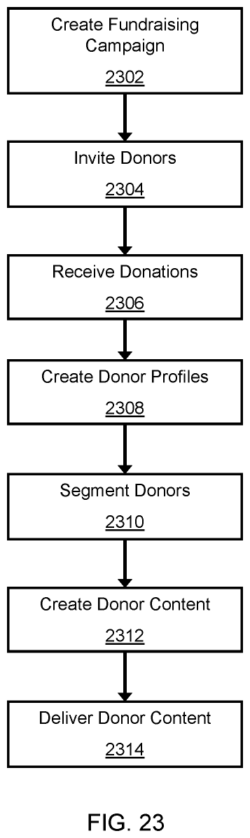

FIG. 23 is a flow diagram illustrating an example process for managing a fundraiser, according to an embodiment of the invention. In step 2302, a fundraiser creates a fundraising campaign using the application, then, in step 2304, invites donors to donate to the campaign. In step 2306, donations are received from the donors, and in step 2308, donor profiles are created of the donors to analyze their frequency, amount, recency and other factors relevant to their donation. In step 2310, segments of donors are created based on the data in the donor profiles. In step 2312, donor-specific content is created for the different segments of donors based on each segment, and in step 2314, the donor-specific content is delivered to the donors to engage and retain the donors.

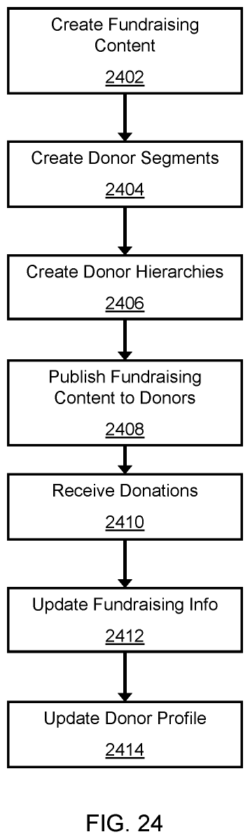

FIG. 24 is a flow diagram illustrating a further exemplary process for managing a fundraiser, according to an embodiment of the invention. In step 2402, fundraising content is created using the fundraising platform, then, in step 2404, segments of donors are created to determine which donors will receive which content. In step 2406, donor hierarchies are created and utilized to determine how the donors will receive the content, and in step 2408, the content is published to the donors via the segmentation and hierarchical communication protocols. In step 2410, donations are received through the donor platform using the links and other interactive features created to receive the donations and forward them to the fundraiser organizers via the payment gateways. In step 2412, information on the donations is updated to the fundraising profile for viewing in the organizer's dashboard, and in step 2414, the donor-profiles are updated based on donor activity such as frequency, amount, recency and other factors relevant to their donation.

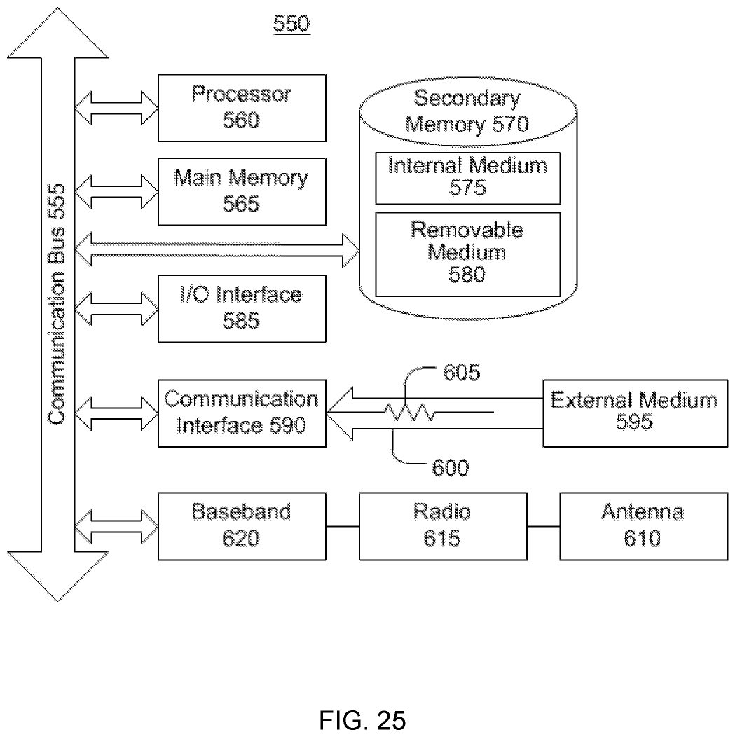

FIG. 25 is a block diagram illustrating an example wired or wireless system 550 that may be used in connection with various embodiments described herein. For example the system 550 may be used as or in conjunction with a system and method for managing fundraisers as previously described with respect to FIGS. 1-24. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A system for managing fundraising, the system comprising:
a content engine which creates content related to at least one fundraiser for publishing to a plurality of donors;
a segmentation engine which creates, manages and selects segments of the plurality of donors to receive customized content selected from the created content;
a hierarchy engine which publishes the customized content to the selected segments of donors using a prioritized hierarchy of communication mediums; and
a donation platform which receives donations from the plurality of donors for the at least one fundraiser.

2. The system of claim 1, wherein the content engine receives content from a collaborator carrying out activities with donated funds.

3. The system of claim 1, wherein the customized content is customized for different segments of donors.

4. The system of claim 1, wherein the segments of donors are dynamically updated based on real-time donation information.

5. The system of claim 1, wherein the segments of donors are created based on donor activity in relation to the fundraiser.

6. The system of claim 5, wherein the donor activity is related to one or more of: a donor's recency of activity, a donor's frequency of activity, and a donor's monetary activity.

7. (canceled)

8. The system of claim 1, wherein the prioritized hierarchy of communication mediums is selected by the donor.

9. The system of claim 1, wherein the prioritized hierarchy of communication mediums is selected by an organization sponsoring the fundraiser.

10. (canceled)

11. (canceled)

12. The system of claim 1, wherein the system further comprises a fundraiser analytics engine which analyzes donation data related to the at least one fundraiser.

13. The system of claim 1, wherein the fundraiser analytics engine analyzes interactions between the donors and the published customized content.

14.-28. (canceled)

29. A method for managing fundraising, the method comprising:
creating content related to at least one fundraiser for publishing to a plurality of donors;
creating, managing and selecting segments of the plurality of donors to receive customized content selected from the created content;
publishing the customized content to the selected segments of donors using a prioritized hierarchy of communication mediums; and
receiving donations from the plurality of donors for the at least one fundraiser.

30. The method of claim 29, further comprising receiving content from a collaborator carrying out activities with donated funds.

31. The method of claim 29, further comprising customizing the content for different segments of donors.

32. The method of claim 29, further comprising dynamically updating the segments of donors based on real-time donation information.

33. The method of claim 29, further comprising creating the segments of donors based on donor activity in relation to the fundraiser.

34. The system of claim 33, wherein the donor activity is related to one or more of: a donor's recency of activity, a donor's frequency of activity, and a donor's monetary activity.

35. (canceled)

36. The method of claim 29, further comprising receiving the prioritized hierarchy of communication mediums from the plurality of donors.

37. The method of claim 29, wherein the prioritized hierarchy of communication mediums is selected by an organization sponsoring the fundraiser.

38. (canceled)

39. The method of claim 29, further comprising processing donations from the plurality of donors with a payment gateway maintained by an organizer of the fundraiser.

40. The method of claim 29, further comprising analyzing donation data related to the at least one fundraiser and the donors which provided donations.
